(19) United States
(12) Patent Application Publication
(10) Pub. No.: US 2025/0385308 A1
(43) Pub. Date: Dec. 18, 2025

(54) ELECTROLYTE SOLUTION FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Sohee KIM, Yongin-si (KR); HYUNBONG CHOI, Yongin-si (KR); Sangwoo PARK, Yongin-si (KR); Woojung JI, Yongin-si (KR); Hongryeol PARK, Yongin-si (KR); Yeji YANG, Yongin-si (KR); Dasol JUN, Yongin-si (KR); Youngkyeong SHIN, Yongin-si (KR); SANGHOON KIM, Yongin-si (KR)

(21) Appl. No.: 19/059,166

(22) Filed: Feb. 20, 2025

(30) Foreign Application Priority Data
Jun. 13, 2024 (KR) 10-2024-0076847

(51) Int. Cl. H01M 10/0567; H01M 4/02; H01M 4/131; H01M 4/133; H01M 4/134; H01M 4/136; H01M 4/38; H01M 4/485; H01M 4/58; H01M 4/583; H01M 10/0525; H01M 10/0568; H01M 10/0569

(52) U.S. Cl. CPC H01M 10/0567; H01M 4/131; H01M 4/133; H01M 4/134; H01M 4/136; H01M 4/386; H01M 4/485; H01M 4/5825; H01M 4/583; H01M 10/0525; H01M 10/0568; H01M 10/0569; H01M 2004/027; H01M 2004/028; H01M 2300/0051

(57) ABSTRACT

Provided are an electrolyte solution for a rechargeable lithium battery and a rechargeable lithium battery including the same, wherein the electrolyte solution includes a non-aqueous organic solvent, a lithium salt, a first additive represented by Formula 1 above, and a second additive represented by Formula 2 above.

### CROSS-REFERENCE TO RELATED APPLICATION

The present application claims priority to and the benefit of Korean Patent Application No. 10-2024-0076847, filed on Jun. 13, 2024, in the Korean Intellectual Property Office, the entire content of which is hereby incorporated by reference.

### BACKGROUND

### 1. Field

Embodiments of the present disclosure herein relate to an electrolyte solution for a rechargeable lithium battery and a rechargeable lithium battery including the same.

### 2. Description of the Related Art

Lately, the rapid spread of battery-powered electronics, such as mobile phones, laptop computers, and electric vehicles, has driven a sharp rise in interest in rechargeable batteries having high energy density and high capacity. Accordingly, extensive research efforts are directed towards improving the performance of rechargeable lithium batteries.

Rechargeable lithium batteries include a positive electrode and a negative electrode, each including an active material that allows intercalation and deintercalation of lithium ions, and an electrolyte solution, and produce electrical energy from redox reactions that take place as lithium ions are intercalated into or deintercalated from the positive electrode and the negative electrode.

One, in which a lithium salt is dissolved in a non-aqueous organic solvent, is used as an electrolyte of the rechargeable lithium batteries. The rechargeable lithium batteries exhibit characteristics thereof through complex reactions between the positive electrode and the electrolyte and between the negative electrode and the electrolyte. Thus, the use of a suitable or appropriate electrolyte is one of the critical variables for improving performance of rechargeable lithium batteries.

### SUMMARY

Embodiments of the present disclosure provide an electrolyte solution for a rechargeable lithium battery, having improved lifetime characteristics and stability at high temperatures.

Embodiments of the present disclosure also provide a rechargeable lithium battery including the electrolyte solution.

An embodiment of the present disclosure provides an electrolyte solution for a rechargeable lithium battery, which includes a non-aqueous organic solvent, a lithium salt, a first additive represented by Formula 1 below, and a second additive represented by Formula below 2:

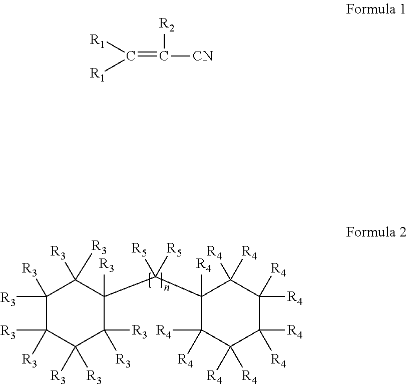

in Formula 1 above,
R₁'s are each independently hydrogen or a substituted or unsubstituted alkyl group having 1 to 10 carbon atoms,
R₂ is hydrogen, a substituted or unsubstituted alkyl group having 1 to 10 carbon atoms, a substituted or unsubstituted alkenyl group having 2 to 10 carbon atoms, or a substituted or unsubstituted aryl group having 6 to 20 carbon atoms, and
in Formula 2 above,
R₃'s are each independently hydrogen, halogen, an alkyl group having 1 to carbon atoms, or an isocyanate group, wherein at least one of R₃'s is an isocyanate group,
R₄'s are each independently hydrogen, halogen, an alkyl group having 1 to carbon atoms, or an isocyanate group, wherein at least one of R₄'s is an isocyanate group,
R₅'s are each independently hydrogen or a cyclohexyl isocyanate residue, and
n above is an integer of 1 to 10.

In an embodiment of the present disclosure, a rechargeable lithium battery includes a positive electrode including a positive electrode active material, a negative electrode including a negative electrode active material, and an electrolyte solution, wherein the electrolyte solution includes a non-aqueous organic solvent, a lithium salt, a first additive represented by Formula 1 above, and a second additive represented by Formula 2 above.

### BRIEF DESCRIPTION OF THE DRAWINGS

The accompanying drawings are included to provide a further understanding of the subject matter of the present disclosure, and are incorporated in and constitute a part of this specification. The drawings illustrate embodiments of the present disclosure and, together with the description, serve to explain principles of the present disclosure. In the drawings:

FIG. 1 is a simplified conceptual view showing a rechargeable lithium battery according to embodiments of the present disclosure; and

FIGS. 2-5 are views schematically showing rechargeable lithium batteries according to embodiments.

### DETAILED DESCRIPTION

In order to sufficiently understand the configuration and effects of the subject matter of the present disclosure, example embodiments of the present disclosure will be described with reference to the accompanying drawings. It should be noted, however, that the present disclosure is not limited to the following embodiments, and may be implemented in various suitable forms and variously suitably modified. The embodiments herein are provided so that present disclosure will be thorough and complete and will fully convey the scope of the present disclosure to those skilled in the art.

Herein, it will be understood that if (e.g., when) a component is referred to as being on another component, the component may be directly on another component, or an intervening third component may be present. In the drawings, thicknesses of components are exaggerated for effectively describing technical contents. Like reference numerals refer to like elements throughout.

Unless otherwise specified herein, the expression of singular form may include the expression of plural form. In addition, unless otherwise specified, the phrase “A or B” may indicate “A but not B”, “B but not A”, or “A and B”. The terms “comprises” and/or “comprising” used herein do not exclude the presence or addition of one or more other components.

As used herein, the term “combination thereof” may refer to a mixture, a stack, a composite, a copolymer, an alloy, a blend, or a reaction product.

Herein, unless otherwise defined, “substitution” indicates that at least one hydrogen in a substituent or compound is substituted with deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, or a combination thereof.

Specifically, the “substitution” may indicate that at least one hydrogen in a substituent or compound is substituted with deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, the “substitution” may indicate that at least one hydrogen in a substituent or compound is substituted with deuterium, a halogen group, a C1 to C20 alkyl group, a C6 to C30 aryl group, a C1 to C10 fluoroalkyl group, or a cyano group. In embodiments, the “substitution” may indicate that at least one hydrogen in a substituent or compound is substituted with deuterium, a halogen group, a C1 to C5 alkyl group, a C6 to C18 aryl group, a C1 to C5 fluoroalkyl group, or a cyano group. For example, the “substitution” may indicate that at least one hydrogen in a substituent or compound is substituted with deuterium, a cyano group, a halogen group, a methyl group, an ethyl group, a propyl group, a butyl group, a phenyl group, a biphenyl group, a terphenyl group, a trifluoromethyl group, or a naphthyl group.

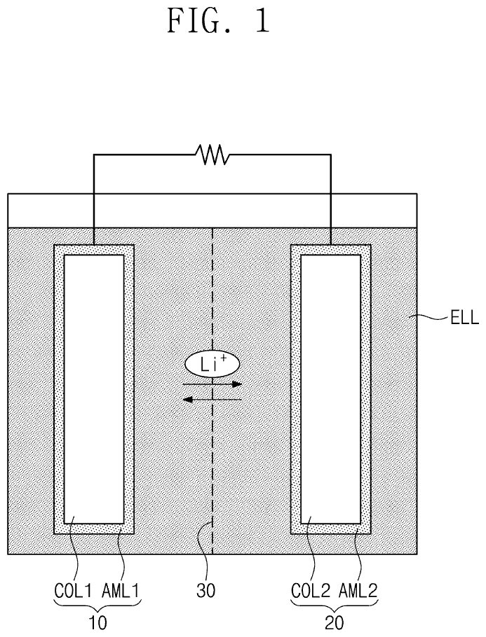

FIG. 1 is a cross-sectional view of a rechargeable lithium battery according to embodiments of the present disclosure. Referring to FIG. 1, the rechargeable lithium battery may include a positive electrode 10, a negative electrode 20, a separator 30, and an electrolyte solution ELL.

The positive electrode 10 and the negative electrode 20 may be spaced apart from each other by the separator 30. The separator 30 may be between the positive electrode 10 and the negative electrode 20. The positive electrode 10, the negative electrode 20 and the separator 30 may be in contact with the electrolyte solution ELL. The positive electrode 10, the negative electrode 20 and the separator may be impregnated in the electrolyte solution ELL.

The electrolyte solution ELL may be a medium that transmits lithium ions between the positive electrode 10 and the negative electrode 20. In the electrolyte solution ELL, the lithium ions may move through the separator 30 toward the positive electrode 10 or the negative electrode 20.

### Positive Electrode 10

The positive electrode 10 for a rechargeable lithium battery may include a current collector COL1 and a positive electrode active material layer AML1 on the current collector. The positive electrode active material layer AML1 may include a positive electrode active material and may further include a binder and/or a conductive material (e.g., an electrically conductive material).

For example, the positive electrode 10 may further include an additive that can serve as a sacrificial positive electrode.

An amount of the positive electrode active material may be about 90 wt % to about 99.5 wt % based on 100 wt % of the positive electrode active material layer AML1. Amounts of the binder and the conductive material may be about 0.5 wt % to about 5 wt %, respectively, based on 100 wt % of the positive electrode active material layer AML1.

The binder serves to attach the positive electrode active material particles well to each other and also to attach the positive electrode active material well to the current collector COL1. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and/or the like, as non-limiting examples.

The conductive material may be used to impart conductivity (e.g., electrical conductivity) to the electrode. Any suitable material that does not cause chemical change (e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder and/or a metal fiber; a conductive polymer (e.g., an electrically conductive polymer) such as a polyphenylene derivative; or a mixture thereof.

Al may be used as the current collector COL1, but is not limited thereto.

### Positive Electrode Active Material

The positive electrode active material may include a compound (lithiated intercalation compound) that is capable of intercalating and deintercalating lithium. For example, at least one selected from among a composite oxide of lithium and a metal selected from cobalt, manganese, nickel, and combinations thereof may be used.

The composite oxide may be a lithium transition metal composite oxide. Examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one selected from among the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}CO_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}CO_{c}L¹_{d}GeO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂GbO₄ (0.90≤a≤1.8 and 0.001≤b≤0.1); LiₐMn_{1-g}G_{g}PO₄ (0.90≤a≤1.8 and 0≤g≤0.5); Li_{(3-f)} Fe₂ (PO₄)₃ (0≤f≤2); or LiₐFePO₄ (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L¹ is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

### Negative Electrode 20

The negative electrode 20 for a rechargeable lithium battery may include a current collector COL2 and a negative electrode active material layer AML2 on the current collector COL2. The negative electrode active material layer AML2 may include a negative electrode active material, and may further include a binder and/or a conductive material (e.g., an electrically conductive material).

For example, the negative electrode active material layer AML2 may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles well to each other and also to attach the negative electrode active material well to the current collector COL2. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

If (e.g., when) an aqueous binder is used as the negative electrode binder, a cellulose-based compound capable of imparting or increasing viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous (e.g., capable of being fiberized). For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart conductivity (e.g., electrical conductivity) to the electrode. Any suitable material that does not cause chemical change (e.g., does not cause an undesirable chemical change in the rechargeable lithium battery) and that conducts electrons can be used in the battery. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder and/or a metal fiber; a conductive polymer (e.g., an electrically conductive polymer) such as a polyphenylene derivative; or a mixture thereof.

The negative current collector COL2 may include a copper foil, a nickel foil, a stainless steel foil, a titanium foil, a nickel foam, a copper foam, a polymer substrate coated with a conductive metal, or a combination thereof.

### Negative Electrode Active Material

The negative electrode active material may include a material that reversibly intercalates/deintercalates lithium ions, a lithium metal, a lithium metal alloy, a material capable of doping/dedoping lithium, and/or a transition metal oxide.

The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, and/or fiber-shaped natural graphite and/or artificial graphite. The amorphous carbon may be a soft carbon, a hard carbon, a mesophase pitch carbonization product, calcined coke, and/or the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material and/or a Sn-based negative electrode active material. The Si-based negative electrode active material may include silicon, a silicon-carbon composite, SiOx (0≤x≤2), and/or a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO₂, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material and/or the Sn-based negative electrode active material may be used in combination with a carbon-based negative electrode active material.

### Separator 30

Depending on the type or kind of the rechargeable lithium battery, the separator 30 may be present between the positive electrode 10 and the negative electrode 20. The separator 30 may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and/or the like.

The separator 30 may include a porous substrate and a coating layer including an organic material, an inorganic material, or a combination thereof on one or both surfaces of the porous substrate.

The porous substrate may be a polymer film formed of any one selected from polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer and/or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked.

### Electrolyte Solution ELL

The electrolyte solution ELL for a rechargeable lithium battery may include a non-aqueous organic solvent and a lithium salt.

The non-aqueous organic solvent may serve as a medium that transmits ions taking part in the electrochemical reaction of a battery.

The non-aqueous organic solvent may be a carbonate-based, ester-based, ether-based, ketone-based, and/or alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like.

The ester-based solvent may include methyl acetate, ethyl acetate, n-propyl acetate, dimethyl acetate, methyl propionate, ethyl propionate, decanolide, mevalonolactone, valerolactone, caprolactone, and/or the like.

The ether-based solvent may include dibutyl ether, tetraglyme, diglyme, dimethoxyethane, 2-methyltetrahydrofuran, 2,5-dimethyltetrahydrofuran, tetrahydrofuran, and/or the like. In embodiments, the ketone-based solvent may include cyclohexanone, and/or the like. The alcohol-based solvent may include ethanol, isopropyl alcohol, and/or the like and the aprotic solvent may include nitriles such as R—CN (wherein R is a C2 to C20 linear, branched, or cyclic hydrocarbon group, a double bond, an aromatic ring, and/or an ether bond, and/or the like); amides such as dimethylformamide; dioxolanes such as 1,3-dioxolane, 1,4-dioxolane, and/or the like; sulfolanes, and/or the like.

The non-aqueous organic solvents may be used alone or in combination of two or more.

In embodiments, if (e.g., when) using a carbonate-based solvent, a cyclic carbonate and a chain carbonate may be mixed and used, and the cyclic carbonate and the chain carbonate may be mixed in a volume ratio of about 1:1 to about 1:9.

The lithium salt dissolved in the organic solvent supplies lithium ions in a battery, enables a basic operation of a rechargeable lithium battery, and improves transportation of the lithium ions between positive and negative electrodes. Examples of the lithium salt include at least one selected from LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂) (C_{y}F_{2y+1}SO₂) (wherein x and y are integers of 1 to 20), lithium trifluoromethane sulfonate, lithium tetrafluoroethanesulfonate, lithium difluoro (oxalato) borate (LiDFOB), lithium difluorobis(oxalato)phosphate (LiDFBOP), and lithium bis(oxalato) borate (LiBOB).

### Rechargeable Lithium Battery

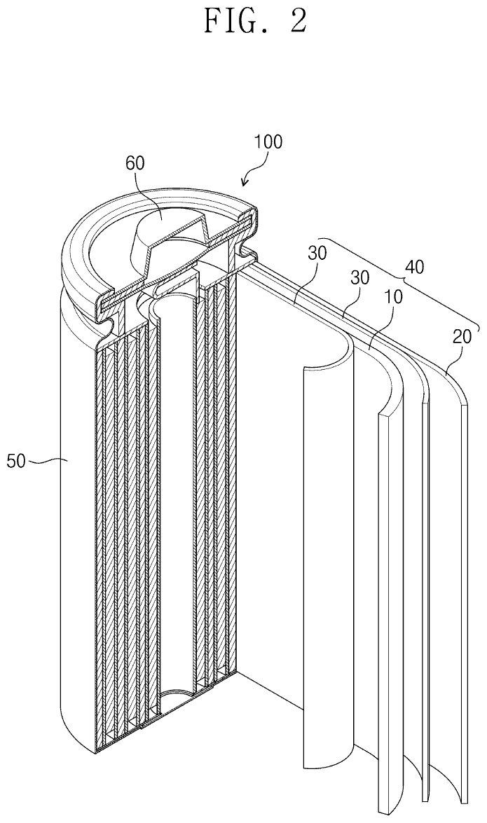

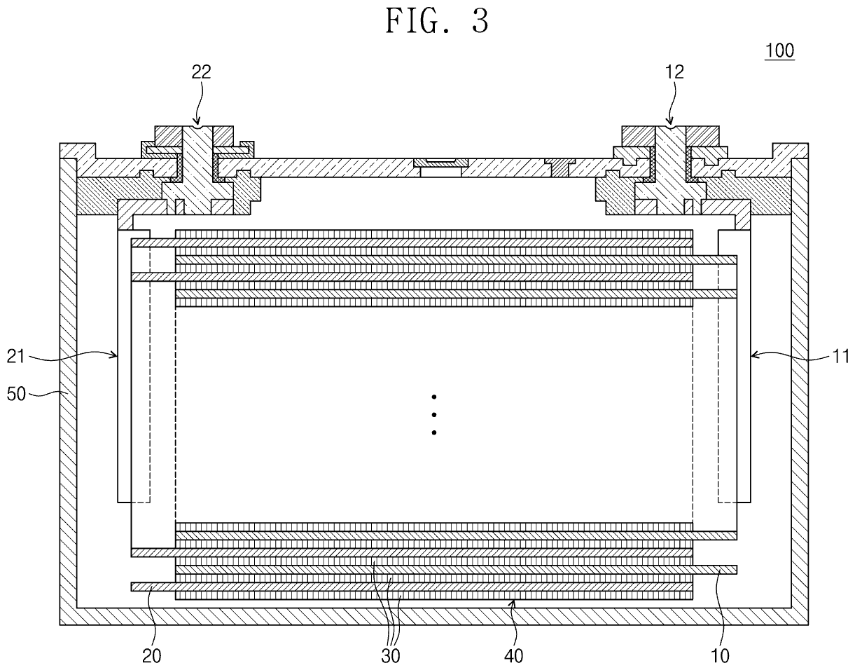

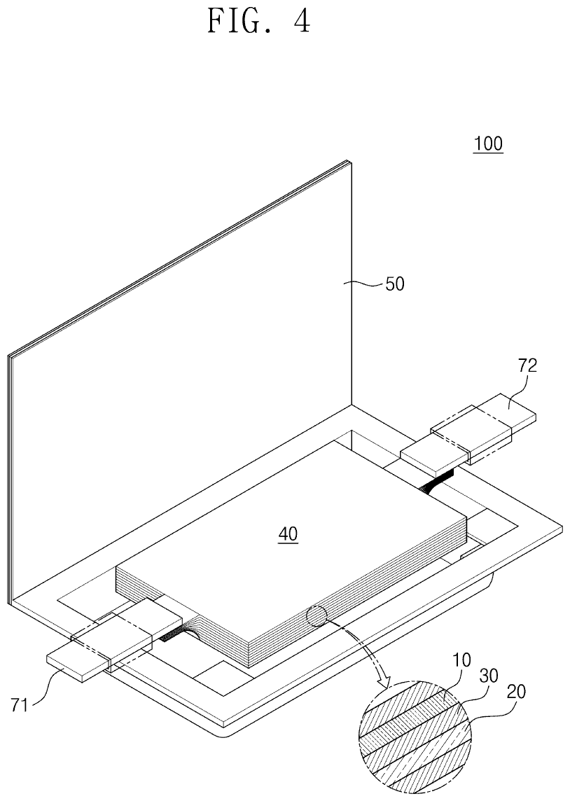

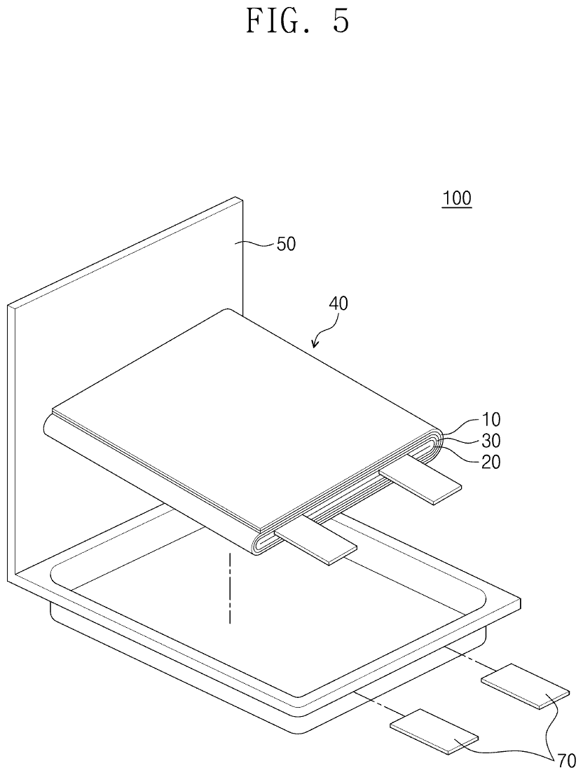

The rechargeable lithium battery may be classified into cylindrical, prismatic, pouch, or coin-type batteries, and/or the like depending on their shape. FIGS. 2 to 5 are schematic views illustrating a rechargeable lithium battery according to an embodiment. FIG. 2 shows a cylindrical battery, FIG. 3 shows a prismatic battery, and FIGS. 4-5 show pouch-type batteries. Referring to FIGS. 2-5, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution. The rechargeable lithium battery 100 may include a sealing member 60 that seals the case 50, as shown in FIG. 2. In FIG. 3, the rechargeable lithium battery 100 may include a positive lead tab 11, a positive terminal 12, a negative lead tab 21, and a negative terminal 22. As shown in FIGS. 4-5, the rechargeable lithium battery 100 may include an electrode tab 70, which may be, for example, a positive electrode tab 71 and a negative electrode tab 72, that serves as an electrical path to induce the current formed in the electrode assembly 40 to the outside.

Hereinafter, an electrolyte solution of a rechargeable lithium battery according to embodiments of the present disclosure will be described in more detail.

The electrolyte solution for a rechargeable lithium battery according to an embodiment may include a non-aqueous organic solvent, a lithium salt, a first additive represented by Formula 1 below which will be further described herein, and a second additive represented by Formula 2 below which will be further described herein.

The electrolyte solution may be prepared by a method through a mixing process in which a lithium salt is dissolved in a non-aqueous organic solvent and the first additive and the second additive are added. The process of mixing the electrolyte solution may be any suitable one generally utilized in the field of electrolyte solution preparation, and may be suitably or appropriately selected and used by a person having ordinary skill in the art.

The non-aqueous organic solvent may include at least one selected from the group consisting of ethylene carbonate (EC), ethyl methyl carbonate (EMC), dimethyl carbonate (DMC), propylene carbonate (PC), propylpropionate (PP), diethyl carbonate (DEC), dipropyl carbonate (DPC), methylpropyl carbonate (MPC), ethylpropyl carbonate (EPC), methylethyl carbonate (MEC), and butylene carbonate (BC).

In an embodiment, the non-aqueous organic solvent may be a mixed solvent of ethylene carbonate (EC), ethyl methyl carbonate (EMC), and dimethyl carbonate (DMC).

As an example, the ethylene carbonate (EC) may be included in an amount of about 10 vol % to about 30 vol % with respect to a total amount of the non-aqueous organic solvent. The ethyl methyl carbonate (EMC) may be included in an amount of about 20 vol % to about 70 vol % with respect to the total amount of the non-aqueous organic solvent. The dimethyl carbonate (DMC) may be included in an amount of about 20 vol % to about 70 vol % with respect to the total amount of the non-aqueous organic solvent.

The lithium salt may be at least one selected from the group consisting of LiPF₆, LiBF₄, LiSbF₆, LiAsF₆, LiClO₄, LiAlO₂, LiAlCl₄, LIPO₂F₂, LICI, LiI, LiN(SOBC₂F₅)₂, Li(FSO₂)₂N (lithium bis(fluorosulfonyl)imide (LiFSI)), and LiC₄F₉SO₃. According to an embodiment, LiPF₆ may be used as the lithium salt.

The lithium salt may have a concentration of about 0.1 M to about 2.0 M. For example, the lithium salt may have a concentration of about 0.5 M or greater or about 1.0 M or greater. The lithium salt may have a concentration of about 2.0 M or less, about 1.7 M or less, or about 1.5 M or less. In the present disclosure, if (e.g., when) the lithium salt has a concentration of about 0.1 M to about 2.0 M, the electrolyte solution may keep conductivity (e.g., electrical conductivity) and viscosity at a suitable or appropriate level.

### First Additive

The first additive according to embodiments of the present disclosure may be represented by Formula 1 below.

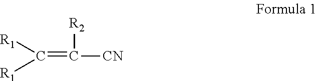

In Formula 1 above, R₁'s may be hydrogen or a substituted or unsubstituted alkyl group having 1 to 10 carbon atoms.

In Formula 1 above, R₂ may be hydrogen, a substituted or unsubstituted alkyl group having 1 to 10 carbon atoms, a substituted or unsubstituted alkenyl group having 2 to 10 carbon atoms, or a substituted or unsubstituted aryl group having 6 to carbon atoms.

In an embodiment, the first additive represented by Formula 1 above may be represented by Formulas 1-1 to Formula 1-3 below.

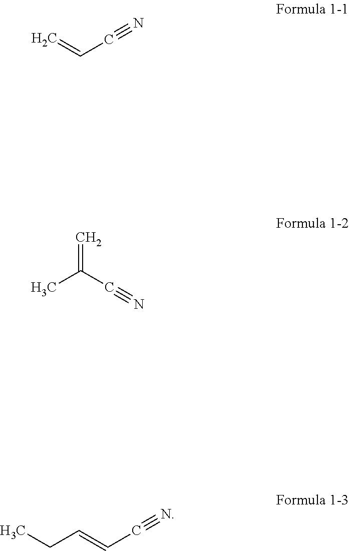

For example, the first additive represented by Formula 1 above may be at least one selected from acrylonitrile, methacrylonitrile, and 2-pentenenitrile.

The first additive may be included in an amount of about 0.01 wt % to about 5 wt % with respect to a total amount of the electrolyte solution. In embodiments, the amount of the first additive may be about 0.1 wt % or greater, about 0.3 wt % or greater, or about 1 wt % or greater with respect to the total amount of the electrolyte solution. The amount of the first additive may be about 4 wt % or less, about 3 wt % or less, or about 1 wt % or less with respect to the total amount of the electrolyte solution. If (e.g., when) the first additive is included in an amount of less than about 0.01 wt % with respect to the total amount of the electrolyte solution, an effect of inhibiting gas generation inside batteries is hardly expected. If (e.g., when) the first additive is included in an amount of greater than about 5 wt % with respect to the total amount of the electrolyte solution, batteries thereof may have reduced initial charge/discharge efficiency and life performance with an increase in usage.

The first additive decomposes before a carbonate-based organic solvent during initial charging and reacts with lithium ions to form an SEI film, and may thus inhibit decomposition of the carbonate-based organic solvent. Accordingly, the gas generation caused by the decomposition of the carbonate-based organic solvent during initial charging may be inhibited, thereby preventing batteries from swelling in thickness (or reducing a swelling in thickness) upon charging at room temperature or storing at high temperature after charging.

### Second Additive

The second additive according to embodiments of the present disclosure may be represented by Formula 2 below.

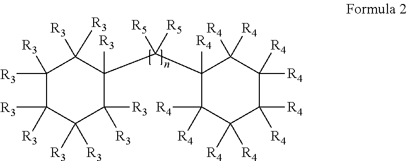

In Formula 2 above, R₃'s may be the same or different, and may each independently be hydrogen, halogen, an alkyl group having 1 to 10 carbon atoms, or an isocyanate group. At least one of R₃'s may be an isocyanate group.

In Formula 2 above, R₄'s may be the same or different, and may each independently be hydrogen, halogen, an alkyl group having 1 to 10 carbon atoms, or an isocyanate group. At least one of R₄'s may be an isocyanate group.

In Formula 2 above, R₃'s may be the same or different, and may each independently be hydrogen or a cyclohexyl isocyanate residue.

In Formula 2, n above may be an integer of 1 to 10.

The positive electrode active material, which is a lithium transition metal oxide, has a stable structure, but otherwise causes elution of transition metal ions and side reactions with moisture if (e.g., when) charged/discharged and stored at high temperatures. This results in degradation in overall cell performance.

The electrolyte solution for a rechargeable lithium battery to which the second additive is applied may effectively inhibit or reduce precipitation on a surface of a negative electrode, which is caused by the elution of transition metal ions from a positive electrode through the control of moisture. Accordingly, degradation in cell performance in the process of charging/discharging and high temperature storage may be effectively prevented or reduced.

In an embodiment, the second additive represented by Formula 2 above may be represented by Formula 2-1 below.

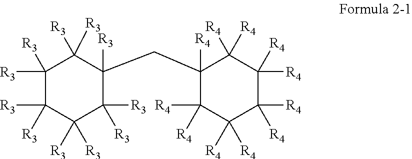

In Formula 2-1 above, R₃'s may be the same or different, and may each independently be hydrogen, halogen, an alkyl group having 1 to 10 carbon atoms, or an isocyanate group. At least one of R₃'s may be an isocyanate group.

In Formula 2 above, R₄'s may be the same or different, and may each independently be hydrogen, halogen, an alkyl group having 1 to 10 carbon atoms, or an isocyanate group. At least one of R₄'s may be an isocyanate group.

In an embodiment, the second additive represented by Formula 2 above may be represented by Formula 2-2 below.

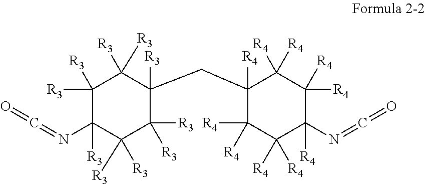

In Formula 2-2 above, R₃'s may be the same or different, and may each independently be hydrogen, halogen, or an alkyl group having 1 to 10 carbon atoms.

In Formula 2-2 above, R₄'s may be the same or different, and may each independently be hydrogen, halogen, or an alkyl group having 1 to 10 carbon atoms

According to an embodiment, Formula 2 above may be represented by Formula 2-2-1 below.

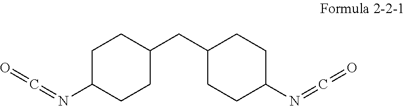 [SMILES: O=C=NC1CCC(CC2CCC(N=C=O)CC2)CC1]

The second additive may be included in an amount of about 0.01 wt % to about 5 wt % with respect to the total amount of the electrolyte solution. For example, the amount of the second additive may be about 0.05 wt % or greater, about 0.1 wt % or greater, or about 0.5 wt % or greater with respect to the total amount of the electrolyte solution. The amount of the second additive may be about 4 wt % or less, about 3 wt % or less, or about 2 wt % or less with respect to the total amount of the electrolyte solution. If (e.g., when) the second additive is included in an amount of less than about 0.01 wt % with respect to the total amount of the electrolyte solution, the effect of resolving the issue caused by transition metal ions eluted from a positive electrode current collector may be insignificant. If (e.g., when) the second additive is included in an amount greater than about 5 wt % with respect to the total amount of the electrolyte solution, there is a risk that lifetime at high temperatures may be reduced in the process of charge/discharge cycles at high temperatures.

A synergistic effect may be generated if (e.g., when) the second additive is used in combination with an additive having an acrylonitrile compound structure (e.g., the first additive described above). The combination of the first additive and the second additive not only may inhibit or reduce the gas generation in the lithium battery and improve high-temperature storage performance of the battery, but also may improve high-temperature cycle and room-temperature cycle stabilities of the battery.

A ratio of the content of the second additive to the content of the first additive in the electrolyte solution may be about 10:1 to about 1:3, specifically about 5:1 to about 1:3. According to an embodiment, the content ratio of the first additive to the second additive may be about 2:1 to about 1:2. In a case in which the amount ratio of the first additive to the second additive is less than the above range, the effect of suppressing or reducing the resistance at high temperature may be insignificant, and, in a case in which the amount ratio of the first additive to the second additive is greater than the above range, lifetime efficiency of the rechargeable lithium battery may be rapidly reduced.

Therefore, the electrolyte solution according to the present disclosure allows a stable SEI film to be formed at an interface between the negative electrode and the electrolyte solution through using the first additive and thus inhibits or reduces the precipitation of lithium dendrites, and prevents or reduces degradation of batteries by stably controlling moisture through the second additive, and may thus be effective in improving lifetime characteristics and stability at high temperatures if (e.g., when) activating rechargeable batteries.

In another embodiment of the present disclosure, a rechargeable lithium battery which includes a positive electrode including a positive electrode active material, a negative electrode including a negative electrode active material, and an electrolyte solution including a non-aqueous organic solvent, a lithium salt, a first additive represented by Formula 1 above, and a second additive represented by Formula 2 above may be provided.

The rechargeable lithium battery may be applied to automobiles, mobile phones, and/or various suitable types or kinds of electric devices, as non-limiting examples.

The positive electrode active material may include a lithium composite oxide represented by Formula 3 below.

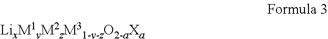

In Formula 3 above,

0.5≤x≤1.8, 0≤a≤0.05, 0<y≤1, 0≤z≤1, and 0≤y+z≤1 may be satisfied,
M¹, M², and M³ may each independently include at least one element selected from metals of nickel (Ni), cobalt (Co), manganese (Mn), aluminum (Al), boron (B), barium (Ba), calcium (Ca), cerium (Ce), chromium (Cr), iron (Fe), molybdenum (Mo), niobium (Nb), silicon (Si), strontium (Sr), magnesium (Mg), titanium (Ti), vanadium (V), tungsten (W), zirconium (Zr), or lanthanum (La), and a combination thereof, and
X may include at least one element selected from fluorine (F), sulfur(S), phosphorus (P), or chlorine (Cl).

In an embodiment, in Formula 3 above, M¹ may be Ni, and 0.8≤y≤1 and ≤z≤0.2 may be satisfied. In embodiments, the positive electrode active material may include a lithium iron phosphate-based oxide.

The negative electrode active material may include at least one of graphite or a Si composite.

If (e.g., when) the negative active material includes both the Si composite and the graphite, the Si composite and the graphite may be included in the form of a mixture, and in this case, the Si composite and the graphite may be included in a weight ratio of about 1:99 to about 50:50. For example, the Si composite and the graphite may be included in a weight ratio of about 3:97 to about 20:80 or about 5:95 to about 20:80.

The Si composite may include a core containing Si-based particles and an amorphous carbon coating layer, and for example, the Si-based particles may include one or more selected from among a Si—C composite, SiOx (0<x≤2), and a Si alloy. For example, the Si—C composite may include a core containing Si particles and crystalline carbon and an amorphous carbon coating layer placed on a surface of the core.

The crystalline carbon may include, for example, graphite, and, for example, may include natural graphite, artificial graphite, or a mixture thereof.

Hereinafter, Examples and Comparative Examples of the present disclosure will be described. However, the following Examples are presented only as embodiments of the present disclosure, and the present disclosure is not limited to Examples below.

### Examples and Comparative Examples

### Example 1

### (1) Preparation of Electrolyte Solution

1.5 M LiPF₆ was dissolved in a non-aqueous organic solvent in which ethylene carbonate (EC), ethyl methyl carbonate (EMC), and dimethyl carbonate (DMC) were mixed in a volume ratio of 20:40:40, and 0.5 wt % of a first additive and 0.5 wt % of a second additive were added to prepare an electrolyte solution.

A compound represented by Formula 1-1 below was used as the first additive. A compound represented by Formula 2-2-1 below was used as the second additive.

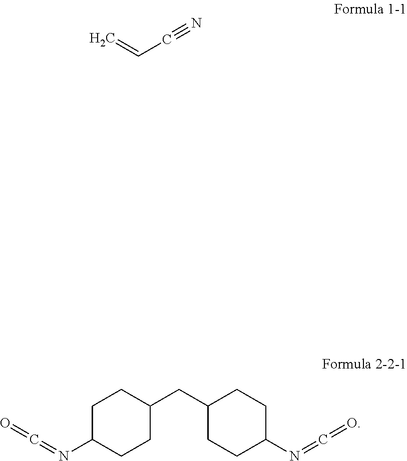

### (2) Preparation of Rechargeable Lithium Battery

LiFePO₄ as a positive electrode active material, polyvinylidene fluoride as a binder, and acetylene black as a conductive material were mixed in a weight ratio of 96:3:1 and dispersed in N-methyl pyrrolidone to prepare a positive electrode active material slurry.

The positive electrode active material slurry was applied onto a 15 μm thick Al foil, dried at 100° C., and then pressed to prepare a positive electrode.

A mixture of artificial graphite and silicon nanoparticles in a weight ratio of 93:7 as a negative electrode active material, styrene-butadiene rubber (SBR) as a binder, and carboxymethyl cellulose (CMC) as a thickener were mixed in a weight ratio of 98:1:1 and dispersed in distilled water to prepare a negative electrode active material slurry.

The negative electrode active material slurry was applied onto a 10 μm thick Cu foil, dried at 100° C., and then pressed to prepare a negative electrode.

An electrode assembly was prepared by assembling the positive electrode, the negative electrode, and a 10 μm thick polyethylene separator, and the electrolyte solution was injected to prepare a rechargeable lithium battery.

### Example 2

An electrolyte solution and a rechargeable lithium battery were prepared in substantially the same manner as in Example 1, except that 0.3 wt % of the first additive was used.

### Example 3

An electrolyte solution and a rechargeable lithium battery were prepared in substantially the same manner as in Example 1, except that 1.0 wt % of the first additive was used.

### Comparative Example 1

An electrolyte solution and a rechargeable lithium battery were prepared in substantially the same manner as in Example 1, except that the first additive represented by Formula 1-1 and the second additive represented by Formula 2-2-1 were not added in the preparation of the electrolyte solution.

### Comparative Example 2

An electrolyte solution and a rechargeable lithium battery were prepared in substantially the same manner as in Example 1, except that the first additive represented by Formula 1-1 was not added in the preparation of the electrolyte solution.

### Comparative Example 3

An electrolyte solution and a rechargeable lithium battery were prepared in substantially the same manner as in Example 1, except that 0.1 wt % of the first additive was used.

### Comparative Example 4

An electrolyte solution and a rechargeable lithium battery were prepared in substantially the same manner as in Example 1, except that Li(NiCoAl)O₂ was used as the positive electrode active material.

### Comparative Example 5

An electrolyte solution and a rechargeable lithium battery were prepared in substantially the same manner as in Example 1, except that Li(NiCoMn)O₂ was used as the positive electrode active material.

### Evaluation Example

The rechargeable lithium batteries were evaluated in the following manner.

### Evaluation 1: Evaluation of Storage Characteristics at High Temperature 60° C.—DC-IR Increase Rate

As ΔV/ΔI (change in voltage/change in current) values for the rechargeable lithium batteries according to Examples and Comparative Examples, initial direct current resistance (DC-IR) was measured, and then the maximum energy state inside the batteries was set to a fully charged state (SOC 100%) and stored at high temperature (60° C.) for 60 days in this condition, and then the direct current resistance was measured and DC-IR increase rate (%) was calculated according to Equation 1 below, and the results are shown in Table 1 below.

$$DC - IR increase rate ( \% ) = {( DC - IR after 60 days / initial DC - IR )}^{*} 100 \qquad Equation 1$$

TABLE 1

| | Initial | DC-IR after high | DC-IR increase rate after |
|---|---|---|---|
| | DC-IR | temperature storage | high temperature storage |
| Item | (mΩ) | (mΩ) | (%) |
| Example 1 | 40.87 | 51.86 | 126.9 |
| Example 2 | 42.38 | 58.78 | 138.7 |
| Example 3 | 45.27 | 66.23 | 146.3 |
| Comparative | 43.14 | 67.86 | 157.3 |
| Example 1 | | | |
| Comparative | 42.61 | 61.32 | 143.9 |
| Example 2 | | | |
| Comparative | 42.84 | 64.09 | 149.6 |
| Example 3 | | | |
| Comparative | 42.51 | 62.49 | 147.0 |
| Example 4 | | | |
| Comparative | 41.55 | 60.33 | 145.2 |
| Example 5 | | | |

### Evaluation 2: Evaluation of Charge/Discharge Cycle Characteristics at High Temperature

Charge/discharge characteristics at room temperature were evaluated for the rechargeable lithium batteries according to Examples and Comparative Examples. To this end, the lithium secondary batteries were charged and discharged 400 times under the following conditions: 25° C., 0.33 C charge (CC/CV, 4.45 V, 0.025° C. cut-off)/1.0 C discharge (CC, 2.5 V cut-off).

Capacity retention was calculated according to Equation 2 below. The results thereof are shown in Table 2 below.

$${Capacity retention ( \% ) = ( discharge capacity after 400 th cycle ) / ( discharge capacity after 1 st cycle ) \}}^{*} 100 \qquad Equation 2$$

TABLE 2

| | 25° C., 400 cycles |
|---|---|
| | Capacity retention (%) |
| Example 1 | 97.6 |
| Example 2 | 90.7 |
| Example 3 | 93.1 |
| Comparative | 76.7 |
| Example 1 | |
| Comparative | 84.6 |
| Example 2 | |
| Comparative | 81.8 |
| Example 3 | |
| Comparative | 82.0 |
| Example 4 | |
| Comparative | 80.9 |
| Example 5 | |

### Evaluation 3: Charge/Discharge Cycle Characteristics at High Temperature (45° C.)

Charge/discharge characteristics at high temperatures were evaluated for the rechargeable lithium batteries according to Examples and Comparative Examples. To this end, the lithium secondary batteries were charged and discharged 400 times under the following conditions: 45° C., 0.33 C charge (CC/CV, 4.45 V, 0.025° C. cut-off)/1.0 C discharge (CC, 2.5 V cut-off).

Capacity retention was calculated according to Equation 3 below. The results thereof are shown in Table 3 below.

$${Capacity retention ( \% ) = ( discharge capacity after 400 th cycle ) / ( discharge capacity after 1 st cycle ) \}}^{*} 100 \qquad Equation 3$$

TABLE 3

| | 45° C., 400 cycles |
|---|---|
| | Capacity retention (%) |
| Example 1 | 84.0 |
| Example 2 | 78.6 |
| Example 3 | 80.3 |
| Comparative | 70.9 |
| Example 1 | |
| Comparative | 78.1 |
| Example 2 | |
| Comparative | 76.9 |
| Example 3 | |
| Comparative | 74.7 |
| Example 4 | |
| Comparative | 73.3 |
| Example 5 | |

### Comprehensive Evaluation

Referring to Table 1 above, it was determined that if (e.g., when) used, the electrolyte solution according to an embodiment of the present disclosure had enhanced DC-IR increase rate if (e.g., when) left at high temperature (60° C.) compared to the electrolyte solution according to Comparative Examples.

Referring to Tables 2 and 3 above, it was determined that if (e.g., when) used, the electrolyte solution according to an embodiment of the present disclosure had enhanced capacity retention from charge/discharge cycles at room temperature and high temperature (45° C.) compared to the electrolyte solution according to Comparative Examples.

Furthermore, it was determined that the electrolyte solution according to an embodiment of the present disclosure, if (e.g., when) used in combination with a positive electrode using lithium iron phosphate as an active material, had excellent cycle characteristics and lifetime efficiency at room temperature and high temperature (45° C.).

An electrolyte solution according to an embodiment uses a combination of a first additive containing an acrylonitrile compound and a second additive containing an isocyanate group, and may thus produce the effect of improving lifetime characteristics and stability at high temperatures if (e.g., when) activating rechargeable batteries.

Although example embodiments of the present disclosure have been described above, the scope of the present disclosure is not limited to the embodiments. Various suitable modifications of the embodiments may be made without departing from the spirit and scope of the disclosure as defined by the appended claims and equivalents thereof, and the modifications are included in the scope of the present disclosure.

What is claimed is:

1. An electrolyte solution for a rechargeable lithium battery, comprising:
a non-aqueous organic solvent;
a lithium salt;
a first additive represented by Formula 1 below; and
a second additive represented by Formula 2 below: 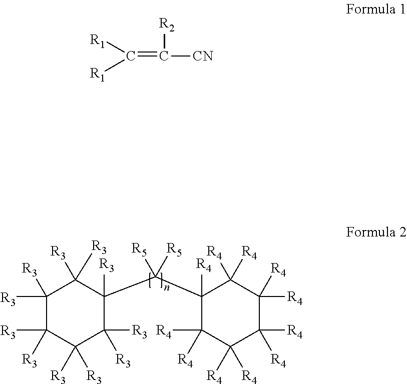
wherein in Formula 1 above,
R₁'s are each independently hydrogen or a substituted or unsubstituted alkyl group having 1 to 10 carbon atoms, and
R₂ is hydrogen, a substituted or unsubstituted alkyl group having 1 to 10 carbon atoms, a substituted or unsubstituted alkenyl group having 2 to 10 carbon atoms, or a substituted or unsubstituted aryl group having 6 to 20 carbon atoms, and
wherein in Formula 2 above,
R₃'s are each independently hydrogen, halogen, an alkyl group having 1 to 10 carbon atoms, or an isocyanate group, wherein at least one of R₃'s is an isocyanate group,
R₄'s are each independently hydrogen, halogen, an alkyl group having 1 to 10 carbon atoms, or an isocyanate group, wherein at least one of R₄'s is an isocyanate group,
R₃'s are each independently hydrogen or a cyclohexyl isocyanate residue, and
n above is an integer of 1 to 10.

2. The electrolyte solution for a rechargeable lithium battery as claimed in claim 1, wherein the first additive is represented by Formulas 1-1 to 1-3 below:

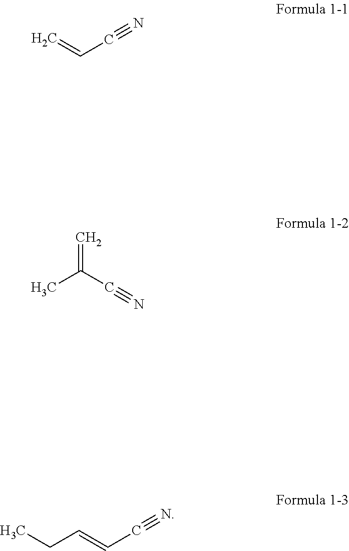

3. The electrolyte solution for a rechargeable lithium battery as claimed in claim 1, wherein the second additive is represented by Formula 2-1 below: 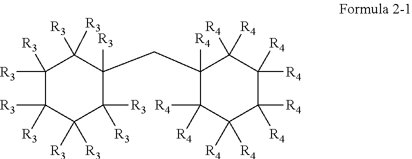
wherein in Formula 2-1 above,
R₃'s are each independently hydrogen, halogen, an alkyl group having 1 to 10 carbon atoms, or an isocyanate group, wherein at least one of R₃'s is an isocyanate group, and
R₄'s are each independently hydrogen, halogen, an alkyl group having 1 to 10 carbon atoms, or an isocyanate group, wherein at least one of R₄'s is an isocyanate group.

4. The electrolyte solution for a rechargeable lithium battery as claimed in claim 1, wherein the second additive is represented by Formula 2-2 below: 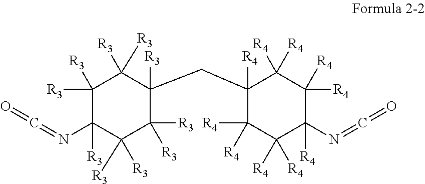
wherein in Formula 2-2 above,
R₃'s are each independently hydrogen, halogen, or an alkyl group having 1 to 10 carbon atoms, and
R₄'s are each independently hydrogen, halogen, or an alkyl group having 1 to 10 carbon atoms.

5. The electrolyte solution for a rechargeable lithium battery as claimed in claim 1, wherein an amount of the first additive is about 0.01 wt % to about 5 wt % with respect to a total weight of the electrolyte solution.

6. The electrolyte solution for a rechargeable lithium battery as claimed in claim 1, wherein an amount of the second additive is about 0.01 wt % to about 5 wt % with respect to a total weight of the electrolyte solution.

7. The electrolyte solution for a rechargeable lithium battery as claimed in claim 1, wherein a content ratio of the first additive represented by Formula 1 above to the second additive represented by Formula 2 above is about 10:1 to about 1:3.

8. The electrolyte solution for a rechargeable lithium battery as claimed in claim 1, wherein the non-aqueous organic solvent further comprises a carbonate-based solvent, and
the carbonate-based solvent comprises at least one selected from the group consisting of ethylene carbonate (EC), ethyl methyl carbonate (EMC), dimethyl carbonate (DMC), propylene carbonate (PC), propylpropionate (PP), diethyl carbonate (DEC), dipropyl carbonate (DPC), methylpropyl carbonate (MPC), ethylpropyl carbonate (EPC), methylethyl carbonate (MEC), and butylene carbonate (BC).

9. The electrolyte solution for a rechargeable lithium battery as claimed in claim 1, wherein the lithium salt is at least one selected from the group consisting of LiPF₆, LiClO₄, LiBF₄, (lithium bis(fluorosulfonyl)imide (LiFSI), LiTFSI, LiSO₃CF₃, LiBOB, LiFOB, LiDFBP, LiTFOP, LiPO₂F₂, LiSbF₆, LiAsF₆, LiAlO₂, LiAlCl₄, LiCl, LiI, LiN(SO₃C₂F₅)₂, Li(FSO₂)₂N, and LiC₄F₉SO₃.

10. The electrolyte solution for a rechargeable lithium battery as claimed in claim 1, wherein the lithium salt has a concentration of about 0.1 M to about 2.0 M.

11. A rechargeable lithium battery comprising:
a positive electrode including a positive electrode active material;
a negative electrode including a negative electrode active material; and
an electrolyte solution as claimed in claim 1.

12. The rechargeable lithium battery as claimed in claim 11, wherein the positive electrode active material comprises a lithium composite oxide represented by Formula 3 below: 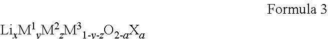
wherein in Formula 3 above,
0.5≤x≤1.8, 0≤a≤0.05, 0<y≤1, 0≤z≤1, and 0≤y+z≤1 are satisfied,
M¹, M², and M³ each independently include at least one element selected from metals of nickel (Ni), cobalt (Co), manganese (Mn), aluminum (Al), boron (B), barium (Ba), calcium (Ca), cerium (Ce), chromium (Cr), iron (Fe), molybdenum (Mo), niobium (Nb), silicon (Si), strontium (Sr), magnesium (Mg), titanium (Ti), vanadium (V), tungsten (W), zirconium (Zr), or lanthanum (La), and a combination thereof, and
X includes at least one element selected from fluorine (F), sulfur(S), phosphorus (P), or chlorine (Cl).

13. The rechargeable lithium battery as claimed in claim 11, wherein the positive electrode active material comprises a lithium iron phosphate-based compound.

14. The rechargeable lithium battery as claimed in claim 11, wherein the negative electrode active material comprises at least one of graphite or a Si composite.

15. The rechargeable lithium battery as claimed in claim 11, wherein the rechargeable lithium battery is a cylindrical battery, a prismatic battery, a pouch-type battery, or a coin-type battery.
